(19) United States
(12) Patent Application Publication
(10) Pub. No.: US 2026/0185925 A1
(43) Pub. Date: Jul. 2, 2026

(54) SYSTEM FOR DETERMINING DEGRADATION CONDITIONS WITHIN A PIPELINE

(71) Applicant: Saudi Arabian Oil Company, Dhahran (SA)

(72) Inventors: Tariq A. Khathami, Dammam (SA); Abdullah M. Salma, Dammam (SA); Abdulrahman E. Sayed, Dammam (SA)

(73) Assignee: Saudi Arabian Oil Company, Dhahran (SA)

(21) Appl. No.: 19/007,974

(22) Filed: Jan. 2, 2025

(51) Int. Cl. G01N 17/04; G01N 17/00

(52) U.S. Cl. CPC G01N 17/046; G01N 17/006

(57) ABSTRACT

A system for determining material degradation conditions within a pipeline comprises a degradation monitoring device comprising a magnetically attractable component and a magnetic positioning system comprising a device engaging magnet and a three-dimensional positioner configured to position the device engaging magnet longitudinally and circumferentially along an exterior surface of the pipeline, wherein the magnetic positioning system is configured to selectively maintain the degradation monitoring device at a plurality of positions within the pipeline via through-wall magnetic coupling between the device engaging magnet and the magnetically attractable component of the degradation monitoring device.

### TECHNICAL FIELD

The present disclosure generally relates to systems and methods for determining material degradation conditions within a hollow structure and, more specifically, to systems and methods for determining material degradation conditions within a pipeline.

### BACKGROUND

Corrosion represents a worldwide challenge in the pipeline transportation, petroleum, and petrochemical industries as it threatens the integrity and shortens the lifetime of equipment and processing units used within these industries. The pipeline transportation industry represents a significant subsector of the petroleum and petrochemical industries where pipelines, sometimes hundreds of kilometers in length, are used to transport fluids from one place to another. Moreover, in the petroleum and petrochemical industries, corrosion may be found in a wide array of equipment types including, but not limited to, storage tanks, reactors, and separators.

In these industries, corrosion occurs when fluids within equipment and processing units react with and degrade the interior surfaces of these components. In addition to the corrosivity of the transported fluids themselves, there are several factors that can influence corrosion rate such as, for example, the presence of moisture in the pipeline as well as the presence of impurities in the fluids being transported. Over time, the degradation caused by corrosion can lead to several problems such as, for example, wall thinning, pitting, and stress cracking, each of which threatens the integrity of the pipeline and will ultimately lead to pipeline failure if left unaddressed. In severe cases, pipeline failure can result in product leakage, environmental contamination, and increased safety hazards.

However, there are various countermeasures that may be employed to prevent and/or reduce corrosion such as, for example, coating or lining the interior of the pipeline or processing unit with a corrosion resistant material, or adding corrosion inhibitors to fluids being transported/processed that forms a corrosion resistant film that protects the interior surfaces from direct contact with corrosive fluids. Additionally, corrosion coupons and other monitoring devices may be used to determine material degradation conditions within a pipeline or processing unit, for example, to monitor the extent and/or rate of corrosion.

### SUMMARY

Corrosion coupons are typically small metallic samples made from the same material as the process unit/pipeline in which they are employed to monitor. Conventionally, these samples are pre-installed at a specific location, left for specific period of time, and then retrieved to assess the condition of the metallic sample and determine how much mass it lost due to corrosion. Being made from the same material as the pipeline, the extent and/or rate of corrosion observed for the corrosion coupon (e.g., as indicated by mass loss) serves as a reliable indicator for the extent and/or rate of corrosion to the interior surfaces of the pipeline. However, these conventional coupons only provide corrosion information with respect to their pre-installed location and cannot be moved from one location to another to provide a broader picture of the material degradation conditions within a pipeline or processing unit. Accordingly, there exists a need for improved systems and methods for determining material degradation conditions within pipelines and processing units in the pipeline transportation, petroleum, and petrochemical industries. Further, there exists a need for improved corrosion coupon designs that facilitate corrosion monitoring within pipelines and processing units.

The present disclosure is directed to systems and methods for determining material degradation conditions within pipelines and processing units. The systems and methods described herein employ a degradation monitoring device and a magnetic positioning system configured to selectively maintain the degradation monitoring device at a plurality of positions within the pipeline via through-wall magnetic coupling between the device engaging magnet and a magnetically attractable component of the degradation monitoring device. The magnetic positioning systems described herein include a device engaging magnet and a three-dimensional positioner configured to position the device engaging magnet longitudinally and circumferentially along an exterior surface of the pipeline or processing unit.

The systems, methods, and degradation monitoring devices described herein may be used to measure the rate and/or extent of any type of material degradation within a pipeline or processing unit, such as, but not limited, to corrosion rate (e.g., microbiologically influenced corrosion or stress corrosion cracking), deposits formation rate (e.g., scale formation rate), and erosion rate. Further, owing to the magnetic positioning system and corresponding features of the degradation monitoring devices described herein, and in contrast to conventional degradation monitoring techniques, the systems, methods, and degradation monitoring devices of the present disclosure may be used to determine material degradation conditions at any desired location within a pipeline or processing unit. Furthermore, the systems, methods, and degradation monitoring devices described herein may be used to generate a corrosion profile for pipeline or processing unit by compiling material degradation conditions determined at a plurality of measurement positions within the pipeline or processing unit.

According to a first aspect of the present disclosure, a system for determining material degradation conditions within a pipeline comprises a degradation monitoring device comprising a magnetically attractable component, and a magnetic positioning system comprising a device engaging magnet and a three-dimensional positioner configured to position the device engaging magnet longitudinally and circumferentially along an exterior surface of the pipeline, wherein the magnetic positioning system is configured to selectively maintain the degradation monitoring device at a plurality of positions within the pipeline via through-wall magnetic coupling between the device engaging magnet and the magnetically attractable component of the degradation monitoring device.

A second aspect includes the first aspect, wherein the degradation monitoring device comprises a corrosion coupon that is the magnetically attractable component.

A third aspect includes the second aspect, wherein the corrosion coupon has an arcuate shape comprising a thickness, a length, and an arc width, and wherein the length of the arcuate shape is greater than or equal to the arc width of the arcuate shape, or the length of the arcuate shape is less than the arc width of the arcuate shape.

A fourth aspect includes the second aspect, wherein the corrosion coupon has a spheroid shape.

A fifth aspect includes any one of the first through fourth aspects, wherein the magnetically attractable component of the degradation monitoring device and the device engaging magnet of the magnetic positioning system define a magnetic coupling force of at least about 0.039 newtons (N).

A sixth aspect includes the first aspect, wherein the degradation monitoring device comprises a corrosion coupon comprising a core that is the magnetically attractable component and an outer shell comprising a test material that is different from a material of the core.

A seventh aspect includes the first aspect, wherein the degradation monitoring device comprises: a corrosion coupon; a first protector positioned on a first side of the corrosion coupon; and a second protector positioned on a second side of the corrosion coupon opposite the first side of the corrosion coupon, wherein at least one of the corrosion coupon, the first protector, or the second protector comprises the magnetically attractable component.

An eighth aspect includes the seventh aspect, wherein: the first protector is coupled to a first side surface of the first side of the corrosion coupon, and the second protector is coupled to a second side surface of the second side of the corrosion coupon, wherein the first side surface is defined by: first longitudinal edges spaced in a longitudinal direction of the degradation monitoring device and defining a length of the first side surface; and first lateral edges spaced in a lateral direction of the degradation monitoring device and defining a width of the first side surface, and wherein the second side surface being is defined by: second longitudinal edges spaced in the longitudinal direction of the degradation monitoring device and defining a length of the second side surface; and second lateral edges spaced in the lateral direction of the degradation monitoring device and defining a width of the second side surface, and wherein: a length of the first protector is greater than the length of the first side surface such that longitudinal end portions of the first protector overhang the first longitudinal edges of the first side surface; a width of the first protector is greater than the width of the first side surface such that lateral end portions of the first protector overhang the first lateral edges of the first side surface; a length of the second protector is greater than the length of the second side surface such that longitudinal end portions of the second protector overhang the second longitudinal edges of the second side surface; and a width of the second protector is greater than the width of the second side surface such that lateral end portions of the second protector overhang the second lateral edges of the second side surface.

A ninth aspect includes the seventh aspect, wherein: the first protector comprises a first plurality of outwardly protruding rotatable spheres; and the second protector comprises a second plurality of outwardly protruding rotatable spheres.

A tenth aspect includes any one of the first through ninth aspects, further comprising an injection system configured to introduce the degradation monitoring device into the pipeline.

According to an eleventh aspect of the present disclosure, a method for determining material degradation conditions within a pipeline comprises: (a) positioning a device engaging magnet at a first external position of the pipeline; (b) introducing a degradation monitoring device into the pipeline, the degradation monitoring device having initial characteristics and comprising a magnetically attractable component; (c) attracting the degradation monitoring device to an initial position adjacent to the first external position via through-wall magnetic coupling between the device engaging magnet and the magnetically attractable component of the degradation monitoring device; (d) moving the device engaging magnet longitudinally and/or circumferentially along an exterior surface of the pipeline to a second external position of the pipeline, thereby causing movement of the degradation monitoring device to a measurement position adjacent to the second external position; (e) maintaining, via through-wall magnetic coupling between the device engaging magnet and the magnetically attractable component of the degradation monitoring device, the degradation monitoring device at the measurement position for a test duration such that the degradation monitoring device acquires modified characteristics; (f) extracting the degradation monitoring device from the pipeline; and (g) comparing the modified characteristics of the degradation monitoring device to the initial characteristics of the degradation monitoring device to determine material degradation conditions associated with the measurement position. The degradation monitoring device of the eleventh aspect may be a degradation monitoring device according to any one of the first through tenth aspects.

A twelfth aspect includes the eleventh aspect, wherein: the degradation monitoring device comprises a corrosion coupon; the initial characteristics of the degradation monitoring device comprise an initial weight of the corrosion coupon; the modified characteristics of the degradation monitoring device comprise a modified weight of the corrosion coupon; and comparing the modified characteristics of the degradation monitoring device to the initial characteristics of the degradation monitoring device comprises determining a difference between the initial weight of the corrosion coupon and the modified weight of the corrosion coupon.

A thirteenth aspect includes the eleventh aspect, wherein: the degradation monitoring device comprises a corrosion coupon; the initial characteristics of the degradation monitoring device comprise an initial surface condition of the corrosion coupon; the modified characteristics of the degradation monitoring device comprise a modified surface condition of the corrosion coupon; and comparing the modified characteristics of the degradation monitoring device to the initial characteristics of the degradation monitoring device comprises comparing the modified surface condition of the corrosion coupon to the initial surface condition of the corrosion coupon.

A fourteenth aspect includes any one of the eleventh through thirteenth aspects, wherein the device engaging magnet is moved longitudinally and circumferentially along the exterior surface of the pipeline to the second external position of the pipeline.

A fifteenth aspect includes any one of the eleventh through fourteenth aspects, wherein (b) comprises introducing the degradation monitoring device into the pipeline using an injection system.

According to a sixteenth aspect of the present disclosure, a method for determining a degradation profile of a pipeline comprises: (h) determining material degradation conditions at a plurality of measurement positions within the pipeline by performing the method of any one of the eleventh through fifteenth aspects, for each measurement position of the plurality of measurement positions; and (i) processing the material degradation conditions determined in (h) to determine the degradation profile of the pipeline.

According to a seventeenth aspect of the present disclosure, a corrosion coupon comprises a core comprising a magnetically attractable material; and an outer shell comprising a test material that is different from the magnetically attractable material of the core.

An eighteenth aspect includes the seventeenth aspect, wherein the corrosion coupon has an arcuate shape comprising: a thickness; a length; an outer radius; an arc width; and an arc height that is less than or equal to 50% of the outer radius.

A nineteenth aspect includes the seventeenth aspect, wherein the corrosion coupon has a spheroid shape.

According to a twentieth aspect of the present disclosure, a system for determining material degradation conditions within a hollow structure comprises a degradation monitoring device comprising a magnetically attractable component, and a magnetic positioning system comprising a device engaging magnet and a three-dimensional positioner configured to position the device engaging magnet longitudinally and circumferentially along an exterior surface of the hollow structure, wherein the magnetic positioning system is configured to selectively maintain the degradation monitoring device at a plurality of positions within the hollow structure via through-wall magnetic coupling between the device engaging magnet and the magnetically attractable component of the degradation monitoring device.

According to a twenty-first aspect of the present disclosure, a corrosion coupon comprises a magnetically attractable material and having an arcuate shape comprising: a thickness; a length; an outer radius; an arc width; and an arc height that is less than or equal to 50% of the outer radius.

According to a twenty-second aspect of the present disclosure, a corrosion coupon comprises a magnetically attractable material and having a spheroid shape.

According to a twenty-third aspect of the present disclosure, a degradation monitoring device comprises: a corrosion coupon; a first protector positioned on a first side of the corrosion coupon; and a second protector positioned on a second side of the corrosion coupon opposite the first side of the corrosion coupon, wherein at least one of the corrosion coupon, the first protector, or the second protector comprises a magnetically attractable component.

Additional features and advantages of the technology disclosed herein will be set forth in the detailed description which follows, and in part will be readily apparent to those skilled in the art from that description or recognized by practicing the technology as described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a system for determining material degradation conditions within a pipeline, according to one or more embodiments described herein;

FIG. 2A schematically depicts an injection system for introducing a degradation monitoring device into a pipeline, at a first step of introducing the degradation monitoring device into the pipeline, according to one or more embodiments described herein;

FIG. 2B schematically depicts an injection system for introducing a degradation monitoring device into a pipeline, at a second step of introducing the degradation monitoring device into the pipeline, according to one or more embodiments described herein;

FIG. 3A schematically depicts an injection system for introducing a degradation monitoring device into a pipeline, at a third step of introducing the degradation monitoring device into the pipeline, according to one or more embodiments described herein;

FIG. 3B schematically depicts an injection system for introducing a degradation monitoring device into a pipeline, at a fourth step of introducing the degradation monitoring device into the pipeline, according to one or more embodiments described herein;

FIG. 4 schematically depicts an embodiment of a degradation monitoring device comprising a corrosion coupon having an arcuate shape, according to one or more embodiments described herein;

FIG. 5 schematically depicts another embodiment of a degradation monitoring device comprising a corrosion coupon having an arcuate shape, according to one or more embodiments described herein;

FIG. 6 schematically depicts an embodiment of a degradation monitoring device comprising a corrosion coupon having a spheroid shape, according to one or more embodiments described herein;

FIG. 7 schematically depicts a cross-section of an embodiment of a degradation monitoring device comprising a corrosion coupon having a core that is a magnetically attractable component, according to one or more embodiments described herein;

FIG. 8A schematically depicts a cross-section of an embodiment of a degradation monitoring device comprising a corrosion coupon interposed between two protectors, wherein the corrosion coupon has a core that is a magnetically attractable component, according to one or more embodiments described herein;

FIG. 8B schematically depicts a cross-section of an embodiment of a degradation monitoring device comprising a corrosion coupon interposed between two protectors, wherein the each of the protectors has a core that is a magnetically attractable component, according to one or more embodiments described herein;

FIG. 9A schematically depicts an embodiment of a degradation monitoring device comprising a corrosion coupon interposed between two protectors, wherein each protector comprises a plurality of outwardly protruding rotatable spheres, according to one or more embodiments described herein;

FIG. 9B schematically depicts the embodiment of FIG. 9A wherein the protectors are shown as transparent to reveal magnetically attractable cores of each protector, according to one or more embodiments described herein; and

FIG. 10 schematically depicts a control system communicatively coupled to components of a system for determining material degradation conditions within in a pipeline, according to one or more embodiments described herein.

### DETAILED DESCRIPTION

Reference will now be made to systems and methods for determining material degradation conditions within pipelines and processing units, as well as degradation monitoring devices that may be used with the systems and methods described herein.

As used herein, the term “degradation monitoring device” refers to a device configured to indicate material degradation conditions within a pipeline or processing unit.

As used herein, the term “material degradation conditions” refers to conditions indicating the rate and/or extent of material degradation within a pipeline or processing unit. Examples of material degradation conditions include, but are not limited to, corrosivity (including microbiologically influenced corrosion (“MIC”)), erosion conditions, scale formation conditions, and stress corrosion cracking conditions. However, the systems and methods of the present disclosure may also be used to monitor other material degradation conditions within a pipeline or processing by using a suitable degradation monitoring device. While measured for a particular material, fluid characteristics, and flow conditions, the material degradation conditions determined by the systems and methods described herein may be used to assess the potential for degradation of other materials exposed to the same fluid characteristics and flow conditions.

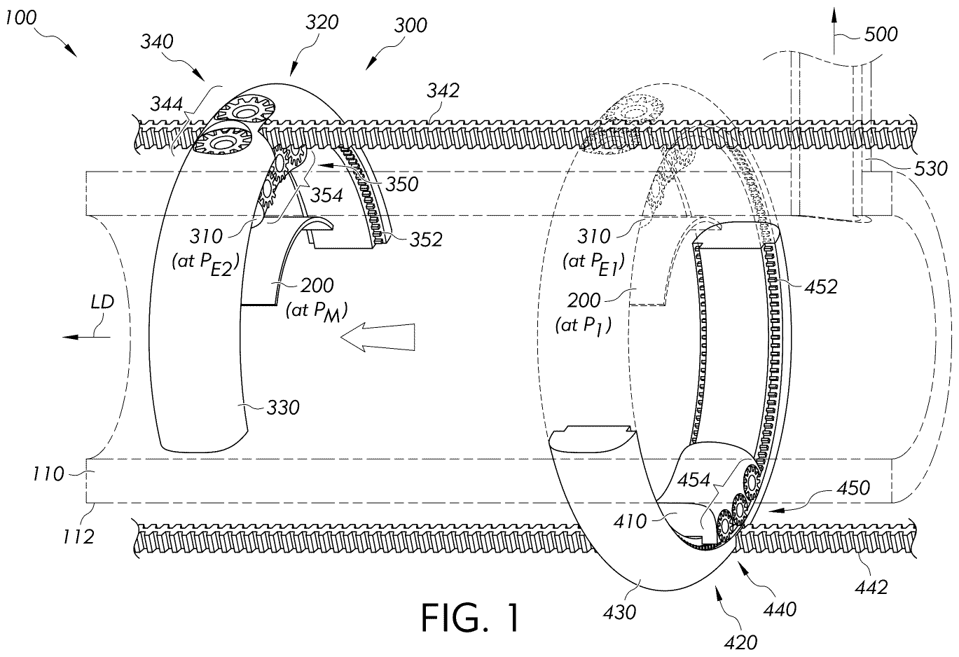

Referring now to FIG. 1, one embodiment of a system 100 of the present disclosure for determining material degradation conditions within a pipeline 110 may include a degradation monitoring device 200 comprising a magnetically attractable component 210, and a magnetic positioning system 300 comprising a device engaging magnet 310 and a three-dimensional positioner 320 configured to position the device engaging magnet 310 longitudinally and circumferentially along an exterior surface 112 of the pipeline 110. The magnetic positioning system 300 is configured to selectively maintain the degradation monitoring device 200 at a plurality of positions within the pipeline 110 via through-wall magnetic coupling between the device engaging magnet 310 and the magnetically attractable component 210 of the degradation monitoring device 200.

In embodiments, the three-dimensional positioner 320 may include magnet support arm 330, an axial positioner subassembly 340, and an angular positioner subassembly 350. The device engaging magnet 310 may be movably coupled to the magnet support arm 330. The axial positioner subassembly 340 is configured to adjust the axial position of the device engaging magnet 310 along the exterior surface 112 of the pipeline 110, and the angular positioner subassembly 350 is configured to adjust the circumferential position of the device engaging magnet 310 along the exterior surface 112 of the pipeline 110. In this manner, the three-dimensional positioner 320 of the magnetic positioning system 300 is able to position the device engaging magnet 310 longitudinally and circumferentially along an exterior surface 112 of the pipeline 110 via operation of the axial positioner subassembly 340 and the angular positioner subassembly 350.

In embodiments, the axial positioner subassembly 340 may include a linear gear track 342 coupled to the exterior surface 112 of the pipeline 110 and a first set of gears 344 coupled to the magnet support arm 330, as shown in FIG. 1. The first set of gears 344 may be further coupled to the linear gear track 342 such that rotation of the first set of gears 344 causes axial movement of the magnet support arm 330, and the device engaging magnet 310 coupled thereto, along the longitudinal direction LD of the pipeline 110. In embodiments, the angular positioner subassembly 350 may include an arc-shaped gear track 352 coupled to the magnet support arm 330 and a second set of gears 354 coupled to the device engaging magnet 310, as shown in FIG. 1. The second set of gears 354 may be further coupled to the arc-shaped gear track 352 such that rotation of the second set of gears 354 causes circumferential movement of the device engaging magnet 310 along the exterior surface 112 of the pipeline 110.

In embodiments, the magnetic positioning system 300 further comprises a second device engaging magnet 410 and a second three-dimensional positioner 420 configured to position the second device engaging magnet 410 longitudinally and circumferentially along an exterior surface 112 of the pipeline 110. The second three-dimensional positioner 420 may include a second magnet support arm 430, a second axial positioner subassembly 440, and a second angular positioner subassembly 450. The second device engaging magnet 410 may be movably coupled to the second magnet support arm 430. The second axial positioner subassembly 440 is configured to adjust the axial position of the second device engaging magnet 410 along the exterior surface 112 of the pipeline 110, and the second angular positioner subassembly 450 is configured to adjust the circumferential position of the second device engaging magnet 410 along the exterior surface 112 of the pipeline 110. In this manner, the second three-dimensional positioner 420 of the magnetic positioning system 300 is able to position the second device engaging magnet 410 longitudinally and circumferentially along an exterior surface 112 of the pipeline 110 via operation of the second axial positioner subassembly 440 and the second angular positioner subassembly 450.

In embodiments, the second axial positioner subassembly 440 may include a second linear gear track 442 coupled to the exterior surface 112 of the pipeline 110 and a third set of gears 444 coupled to the second magnet support arm 430, as shown in FIG. 1. The third set of gears 444 may be further coupled to the second linear gear track 442 such that rotation of the third set of gears 444 causes axial movement of the second magnet support arm 430, and the second device engaging magnet 410 coupled thereto, along the longitudinal direction LD of the pipeline 110. In embodiments, the second angular positioner subassembly 450 may include a second arc-shaped gear track 452 coupled to the second magnet support arm 430 and a fourth set of gears 454 coupled to the second device engaging magnet 410, as shown in FIG. 1. The fourth set of gears 454 may be further coupled to the second arc-shaped gear track 452 such that rotation of the fourth set of gears 454 causes circumferential movement of the second device engaging magnet 410 along the exterior surface 112 of the pipeline 110 (e.g., within a specified distance from the exterior surface 112 of the pipeline 110). The three-dimensional positioner 320 and the second three-dimensional positioner 420 may be configured to pass the degradation monitoring device 200 back-and-forth between the three-dimensional positioner 320 and the second three-dimensional positioner 420 via movement of the first and second device engaging magnets 310, 410 as well as activation/deactivation of the first and second device engaging magnets 310, 410, which is discussed in more detail below.

As noted hereinabove, the device engaging magnet 310 is configured to selectively maintain the degradation monitoring device 200 at a plurality of positions within the pipeline 110 via through-wall magnetic coupling between the device engaging magnet 310 and the magnetically attractable component 210 of the degradation monitoring device 200. The device engaging magnet 310 may be an electromagnet, a permanent magnet, or any other suitable magnet type. The device engaging magnet 310 may be a permanent magnet if the device engaging magnet 310 is capable of being maintained at sufficiently low temperatures (e.g., less than about 100° C.) so as to avoid losing its magnetism, such as, for example, wherein the pipeline being monitored for corrosion is a water utility pipe that has salt deposition on the interior surfaces. If the device engaging magnet 310 is a permanent magnet, a magnetic switchable device may be used to turn on and off the external field of the magnet. If the device engaging magnet 310 is an electromagnet, an electric current may be provided to the electromagnet to activate the device engaging magnet 310 and cause the device engaging magnet 310 to produce a magnetic field. The device engaging magnet 310 may be deactivated by turning off and/or reducing the amount of electric current being supplied to the electromagnet.

The magnetic field produced by the device engaging magnet 310 may be sufficient to attract the degradation monitoring device 200 to an initial position P₁ adjacent to the first external position P_{E1} via through-wall magnetic coupling between the device engaging magnet 310 and the magnetically attractable component 210 of the degradation monitoring device 200. Further, the magnetic field produced by the device engaging magnet 310 may be sufficient to maintain the degradation monitoring device 200 at the initial position P₁ under specified flow conditions, or a range of specified flow conditions, within the pipeline 110. Further, the magnetic field produced by the device engaging magnet 310 may be sufficient such that when the device engaging magnet 310 is moved longitudinally and/or circumferentially along an exterior surface 112 of the pipeline 110 to a second external position P_{E2} of the pipeline 110, a corresponding movement of the degradation monitoring device 200 occurs within the pipeline 110 so as to move the degradation monitoring device 200 to a measurement position P_{M} adjacent to the second external position P_{E2}.

The strength of the magnetic field produced by the device engaging magnet 310 may be determined based on a number of considerations, such as, for example, the distance between the device engaging magnet 310 and the magnetically attractable component 210 of the degradation monitoring device 200, as well as the weight, size, shape, and magnetic permeability of the magnetically attractable component 210. Additionally, characteristics of the fluid being transported within the pipeline 110 as well as characteristics of the degradation monitoring device 200 may also be taken into account. For example, the magnetic field produced by the device engaging magnet 310 may be further determined based on the flow resistance applied to the degradation monitoring device 200 within the pipeline, as determined by the size, shape, and weight of the degradation monitoring device 200 as well as characteristics of the fluid flowing within the pipeline 110 such as, for example, the velocity, viscosity, and density of the fluid flowing within the pipeline 110. In embodiments wherein device engaging magnet 310 is an electromagnetic, the magnetic field produced by the device engaging magnet 310 may be adjustable based on the amount of electric current being supplied to the electromagnet.

In one or more embodiments, the magnetically attractable component 210 of the degradation monitoring device 200 and the device engaging magnet 310 of the magnetic positioning system 300 define a magnetic coupling force of at least about 0.039 newtons (N) to control the position and/or movement of the degradation monitoring device 200 such that, for example, the magnetic positioning system 300 is able to maintain the degradation monitoring device 200 at positions within the pipeline 110 adjacent to the device engaging magnet 310 that is external to the pipeline 110. For example, to achieve a magnetic coupling force of at least about 0.039 N when the magnetically attractable component 210 of the degradation monitoring device 200 is separated from the device engaging magnet 310 by about 5 centimeters (cm), the device engaging magnet 310 may be configured to have a magnetic field strength of about 0.035 tesla (T) at the position of the magnetically attractable component 210. As another example, to achieve a magnetic coupling force of at least about 0.039 N when the magnetically attractable component 210 of the degradation monitoring device 200 is separated from the device engaging magnet 310 by about 10 cm, the device engaging magnet 310 may be configured to have a magnetic field strength of about 0.28 T at the position of the magnetically attractable component 210. In such embodiments, the magnetically attractable component 210 of the degradation monitoring device 200 and the device engaging magnet 310 of the magnetic positioning system 300 may define a magnetic coupling force of at least about 0.039 N at a spacing of about 5 cm to about 10 cm.

In one or more embodiments, the magnetically attractable component 210 of the degradation monitoring device 200 and the device engaging magnet 310 of the magnetic positioning system 300 may define a magnetic coupling force of at least 0.039 N, at least 0.04 N, at least 0.05 N, at least 0.1 N, at least 0.5 N, at least 1.0 N, at least 2.0 N, at least 3.0 N, at least 4.0 N, or at least 5.0 N. In one or more embodiments, the magnetically attractable component 210 of the degradation monitoring device 200 and the device engaging magnet 310 of the magnetic positioning system 300 may define a magnetic coupling force of greater than or equal to 0.039 N and less than or equal to 10 N, greater than or equal to 0.039 N and less than or equal to 5.0 N, greater than or equal to 0.039 N and less than or equal to 4.0 N, greater than or equal to 0.039 N and less than or equal to 3.0 N, greater than or equal to 0.039 N and less than or equal to 2.0 N, or greater than or equal to 0.039 N and less than or equal to 1.0 N.

In one or more embodiments, the magnetically attractable component 210 of the degradation monitoring device 200 and the device engaging magnet 310 of the magnetic positioning system 300 may define a magnetic coupling force of greater than or equal to 0.04 N and less than or equal to 5.0 N, greater than or equal to 0.05 N and less than or equal to 5.0 N, greater than or equal to 0.1 N and less than or equal to 5.0 N, greater than or equal to 0.5 N and less than or equal to 5.0 N, or greater than or equal to 1.0 N and less than or equal to 5.0 N. Further, as noted above, to achieve a particular magnetic coupling force between the magnetically attractable component 210 of the degradation monitoring device 200 and the device engaging magnet 310 of the magnetic positioning system 300, the strength of the magnetic field produced by the device engaging magnet 310 may be set and/or adjusted based the spacing between the magnetically attractable component 210 of the degradation monitoring device 200 and the device engaging magnet 310 of the magnetic positioning system 300, characteristics of the fluid being transported within the pipeline 110, as well as characteristics of the degradation monitoring device 200. For example, for a degradation monitoring device 200 having a weight between 4 grams and 6 grams in a pipeline having a fluid flow rate of between 0 m³/s and 0.5 m³/s, the magnetically attractable component 210 of the degradation monitoring device 200 and the device engaging magnet 310 of the magnetic positioning system 300 may define a magnetic coupling force of between 0.039 N and 0.065 N.

In embodiments, the magnetically attractable component 210 of the degradation monitoring device 200 may be made from a ferromagnetic material (e.g., steel) or a paramagnetic material, provided that the magnetic permeability of the magnetically attractable component 210 allows for a magnetic coupling force between the device engaging magnet 310 and the magnetically attractable component 210 that is sufficient to attract and maintain the degradation monitoring device 200 to positions within the pipeline 110 adjacent to the device engaging magnet 310 positioned external to the pipeline 110.

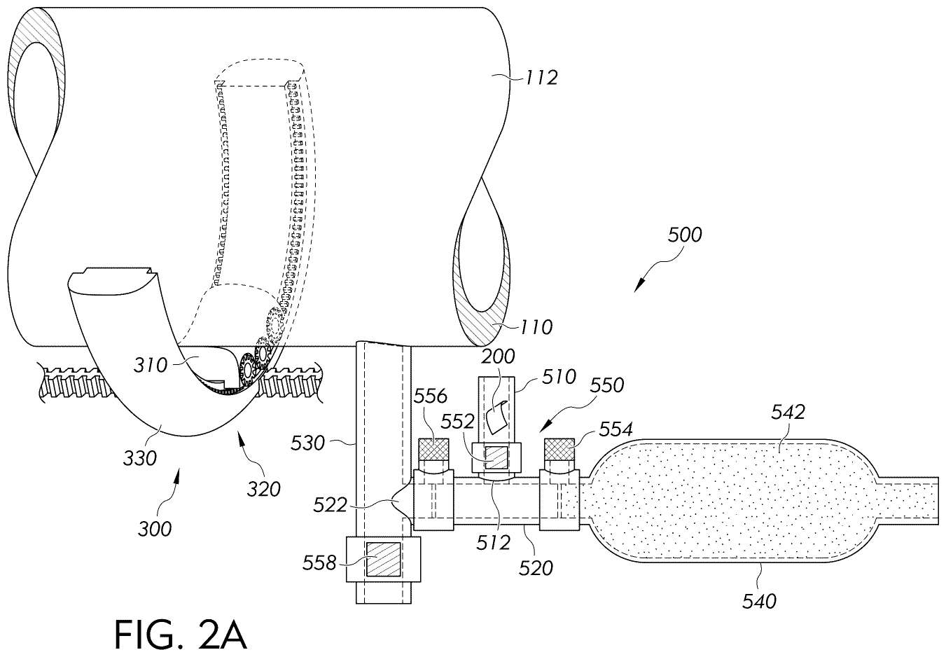

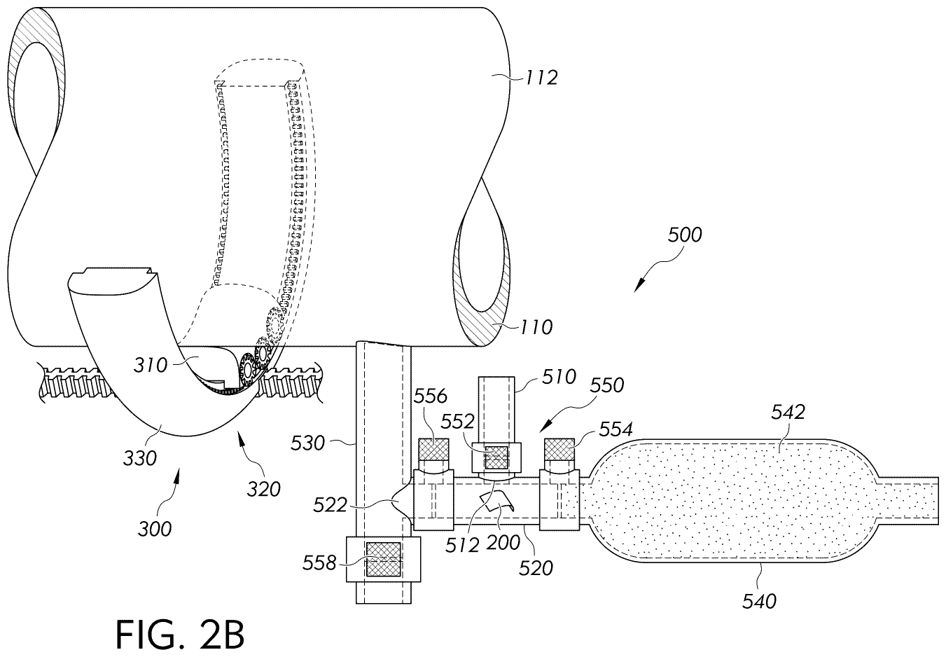

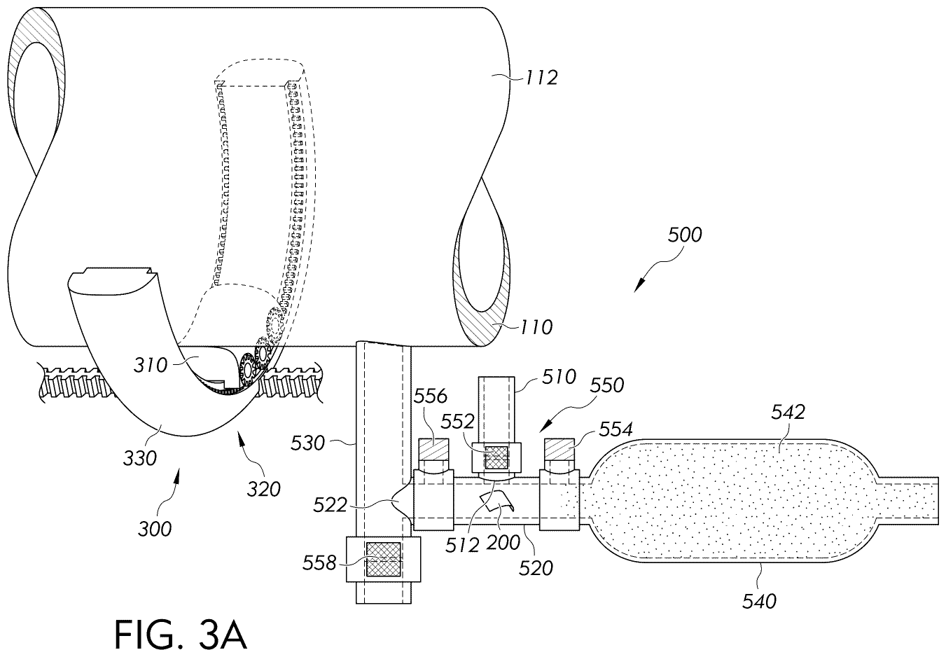

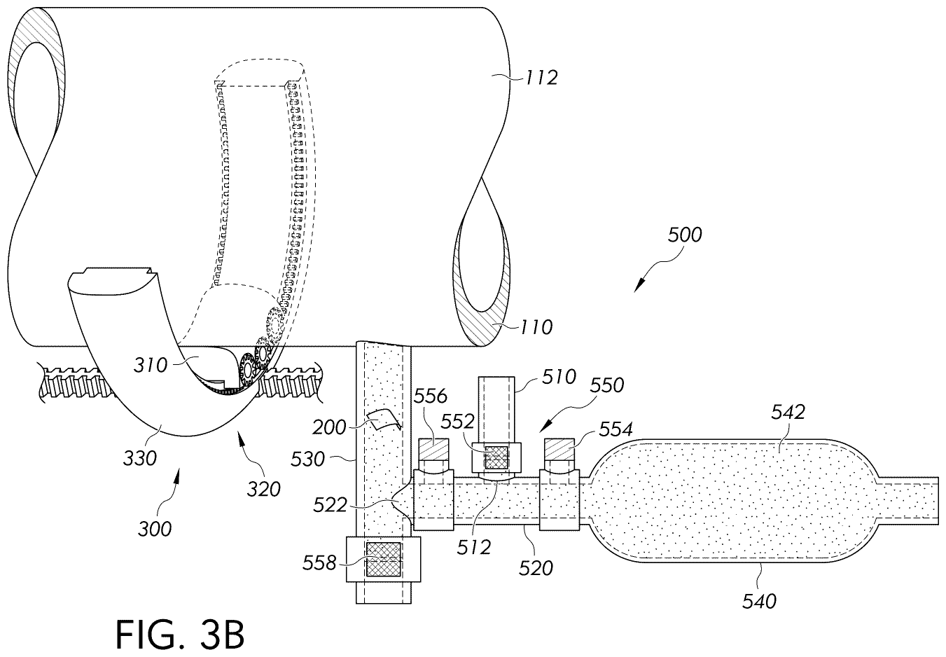

Referring now to FIGS. 2A-3B, the system 100 for determining material degradation conditions within a pipeline 110 may further include an injection system 500 configured to introduce the degradation monitoring device 200 into the pipeline 110. The injection system 500 may include a first channel 510 to which the degradation monitoring device 200 may be introduced to the injection system 500. The injection system 500 may further include a second channel 520 to which the first channel 510 is coupled. The second channel 520 may be coupled at one end to a third channel 530 and at the other end to a carrier fluid tank 540 containing a carrier fluid 542. The carrier fluid 542 may be the same fluid being transported through the pipeline 110 or any other suitable fluid that is able to transport the degradation monitoring device 200 through the injection system 500 and into the pipeline 110. The injection system 500 may further include a valve system 550 configured to allow for the controlled introduction of the degradation monitoring device 200 into the pipeline 110.

The valve system 550 may include a first channel valve 552 coupled to the first channel 510 such that opening and closing of the first channel valve 552 allows fluid and the degradation monitoring device 200 within the first channel to be transported into the second channel 520. The valve system 550 may further include a second channel upstream valve 554 and a second channel downstream valve 556. The second channel upstream valve 554 may be positioned between a first coupling point 512 of the first channel 510 to the second channel 520 and the carrier fluid tank 540, as shown in FIG. 2A. The second channel downstream valve 556 may be positioned between the first coupling point 512 and a second coupling point 522 of the second channel 520 to the third channel 530. After the degradation monitoring device 200 has been introduced into the second channel 520, and after the first channel valve 552 has been closed, as shown in FIG. 2B, the second channel upstream valve 554 and the second channel downstream valve 556 may be opened to allow carrier fluid 542 from the carrier fluid tank 540 to flow through the second channel 520 and into the third channel 530 coupled thereto, thereby causing the degradation monitoring device 200 to flow from the second channel 520 into the third channel 530 and then into the pipeline 110, as shown in FIGS. 3A and 3B. The valve system 550 may further include a third channel valve 558 coupled to the third channel 530, which may be opened and closed to adjust the flow of carrier fluid 542 through the third channel 530 as it carries the degradation monitoring device 200 into the pipeline 110.

The system 100 may further include an extraction system (not shown in figures) configured to extract the degradation monitoring device 200 from the pipeline 110. For example, a net or other suitable device may be inserted through a side channel that is coupled to the pipeline 110 at an extraction location. In embodiments, the magnetic positioning system 300 may be configured to guide the degradation monitoring device 200 to the extraction system. Once extracted, the modified characteristics of the degradation monitoring device 200 may be measured and compared to initial characteristics of the degradation monitoring device 200 to determine material degradation conditions within the pipeline 110. For example, in embodiments wherein the degradation monitoring device 200 comprises a corrosion coupon, the weight loss of the degradation monitoring device 200 and/or other corrosion related characteristics may be automatically measured and reported upon extraction of the degradation monitoring device 200 from the pipeline 110.

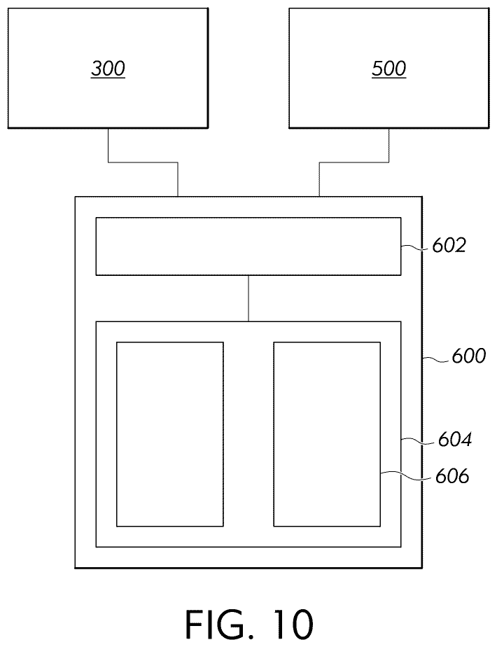

With reference now to FIG. 10, the system 100 may further include a control system 600 communicatively coupled to the magnetic positioning system 300 and the injection system 500. The control system 600 may include at least one processor 602, at least one memory module 604 communicatively coupled to the processor 602, and machine readable and executable instructions 606 stored on the memory module(s) 604. The machine readable and executable instructions 606, when executed by the processor 602, may control operation of the device engaging magnet 310 by, for example, activating and deactivating the device engaging magnet 310 so as to attract and release the degradation monitoring device 200 from adjacent positions within the pipeline 110. Further, the machine readable and executable instructions 606, when executed by the processor 602, may control operation of the magnetic positioning system 300 to position the device engaging magnet longitudinally and circumferentially along an exterior surface of the pipeline. In this manner, the control system 600 is able to selectively maintain the degradation monitoring device 200 at a plurality of positions within the pipeline 110 via through-wall magnetic coupling between the device engaging magnet 310 and the magnetically attractable component 210 of the degradation monitoring device 200. In embodiments wherein the magnetic positioning system 300 includes a second device engaging magnet 410 and second three-dimensional positioner 420, the control system 600 may be used to control operation of the second device engaging magnet 410 and second three-dimensional positioner 420 in the same manner as described above for the device engaging magnet 310 and three-dimensional positioner 320.

Furthermore, the machine readable and executable instructions 606, when executed by the processor 602, may control operation of the injection system 500 and the valve system 550 thereof to introduce the degradation monitoring device 200 into the pipeline 110 in the manner described above.

As noted above, the control system 600 may include the one or more processors 602 and one or more memory modules 604. The one or more processors 602 may include any device capable of executing computer-readable executable instructions stored on a non-transitory computer-readable medium. Accordingly, each processor 602 may include an integrated circuit, a microchip, a computer, and/or any other computing device. The one or more memory modules 604 are communicatively coupled to the one or more processors 602 over a communication path. The one or more memory modules 604 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. The one or more memory modules 604 may be configured to store machine readable and executable instructions 606 for operating one or more components of the system 100.

Embodiments of the present disclosure include logic stored on the one or more memory modules 604 that includes machine-readable and executable instructions or an algorithm written in any programming language of any generation (e.g., 1GL, 2GL, 3GL, 4GL, and/or 5GL) such as, machine language that may be directly executed by the one or more processors 302, assembly language, obstacle-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components.

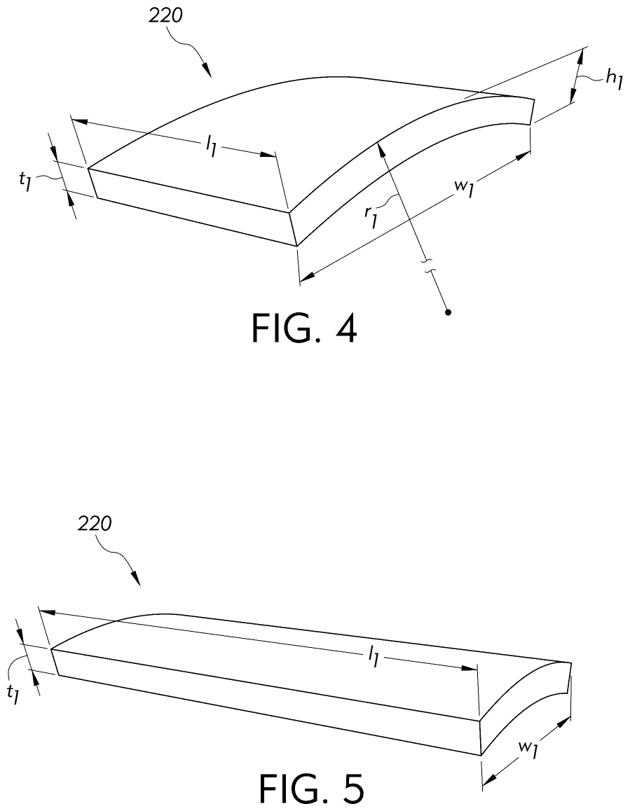

Embodiments of the degradation monitoring device 200 will now be described in more detail. Referring now to FIG. 4, one embodiment of the degradation monitoring device 200 comprises a corrosion coupon 220 that is the magnetically attractable component 210. That is, in the embodiment of the degradation monitoring device 200 shown in FIG. 4, the corrosion coupon 220 is sufficiently sized and formed from a ferromagnetic material or a paramagnetic material having a sufficient magnetic permeability such that the magnetic coupling force between the device engaging magnet 310 and the magnetically attractable component 210 is high enough to attract and maintain the degradation monitoring device 200 at positions within the pipeline 110 adjacent to the device engaging magnet 310 positioned external to the pipeline 110.

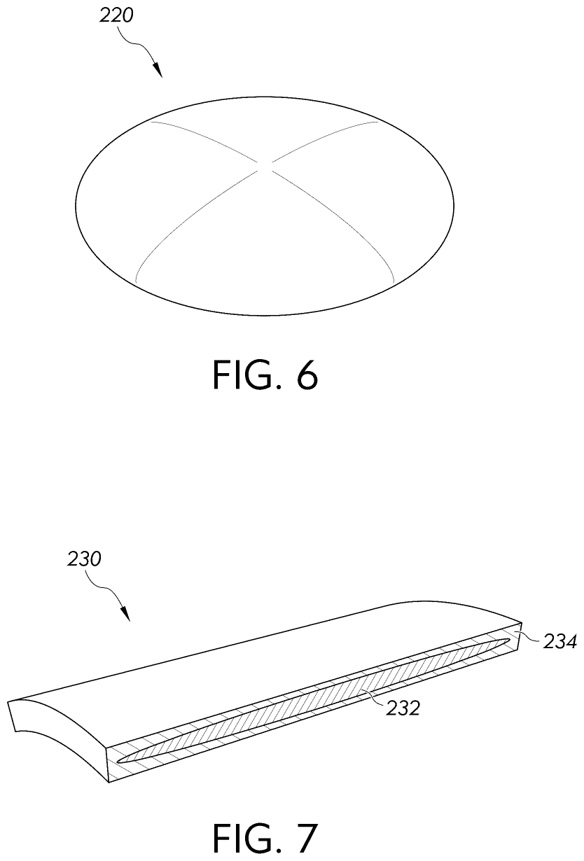

In embodiments, the corrosion coupon 220 may have an arcuate shape comprising a thickness t₁, a length l₁, an arc width w₁, an arc height h₁, and an outer radius r₁. In the embodiment of the corrosion coupon 220 shown in FIG. 4, the corrosion coupon 220 has an arcuate shape wherein the length l₁ of the arcuate shape is less than the arc width w₁ of the arcuate shape. In embodiments, the length l₁ may be less than 0.9×w₁, less than 0.8×w₁, less than 0.7×w₁, less than 0.6×w₁, or less than 0.5×w₁. However, in other embodiments, such as the embodiment shown in FIG. 5, the corrosion coupon 220 has an arcuate shape wherein the length l₁ of the arcuate shape is greater than or equal to the arc width w₁ of the arcuate shape. In embodiments, the length l₁ may be greater than or equal to 1.1×w₁, greater than or equal to 1.2×w₁, greater than or equal to 1.3×w₁, greater than or equal to 1.4×w₁, greater than or equal to 1.5×w₁, greater than or equal to 1.6×w₁, greater than or equal to 1.7×w₁, greater than or equal to 1.8×w₁, greater than or equal to 1.9×w₁, greater than or equal to 2.0×w₁, greater than or equal to 3.0×w₁, greater than or equal to 4.0×w₁, or greater than or equal to 5.0×w₁. In embodiments, the arc height h₁ may be less than or equal to 50%, less than or equal to 40%, less than or equal to 30%, less than or equal to 20%, or less than or equal to 10% of the outer radius r₁ of the arcuate shape. In other embodiments, the corrosion coupon 220 may have a spheroid shape such as an oblate spheroid shape (shown in FIG. 6) or a prolate spheroid shape (not shown in the figures). In further embodiments, the degradation monitoring device 200 may be hollow or partially hollow (e.g., having an open center) to facilitate floating and moving of the degradation monitoring device 200 within the pipeline 100.

With reference now to FIG. 7, in another embodiment, the degradation monitoring device 200 comprises a corrosion coupon 230 comprising a core 232 that is the magnetically attractable component 210 and an outer shell 234 comprising a test material that is different from a material of the core 232. The corrosion coupon 230 may have any suitable shape such as the arcuate and spheroid shapes discussed above. The core 232 of the corrosion coupon 230 may be sized based on anticipated use including, but not limited to, the fluid characteristics and the flow conditions within the pipeline 110, as well as the strength of the magnetic field produced by the device engaging magnet 310.

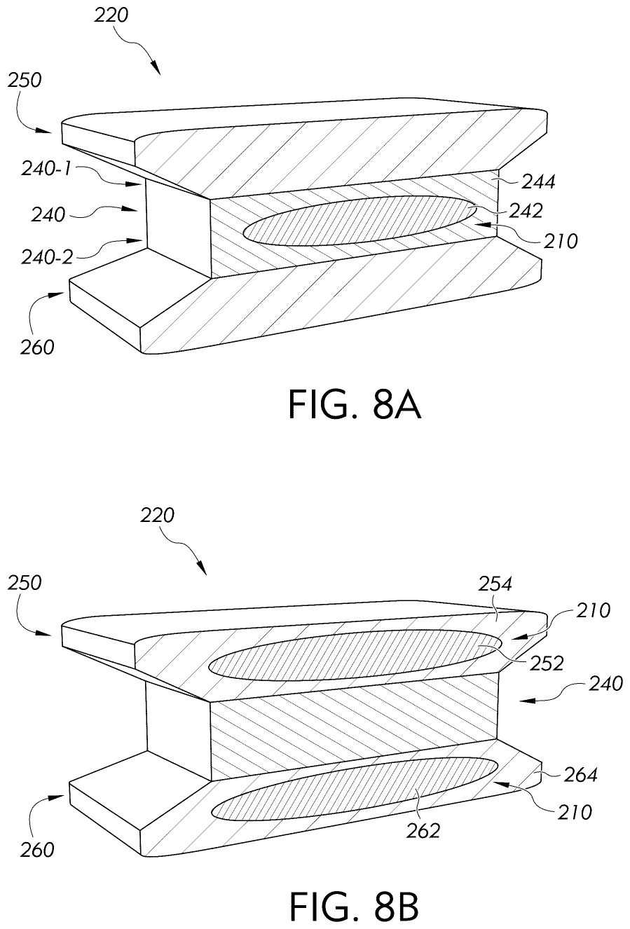

With reference now to FIGS. 8A and 8B, in another embodiment, the degradation monitoring device 200 comprises a corrosion coupon 240, a first protector 250 positioned on a first side 240-1 of the corrosion coupon 240, and a second protector 260 positioned on a second side 240-2 of the corrosion coupon 240 opposite the first side 240-1 of the corrosion coupon 240, wherein at least one of the corrosion coupon 240, the first protector 250, or the second protector 260 comprises the magnetically attractable component 210.

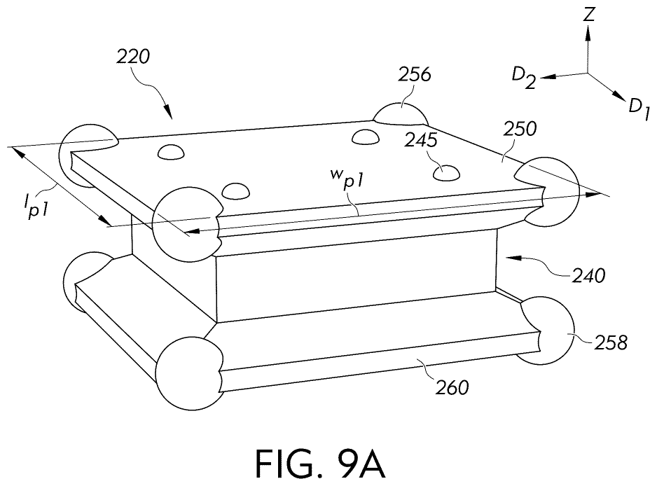

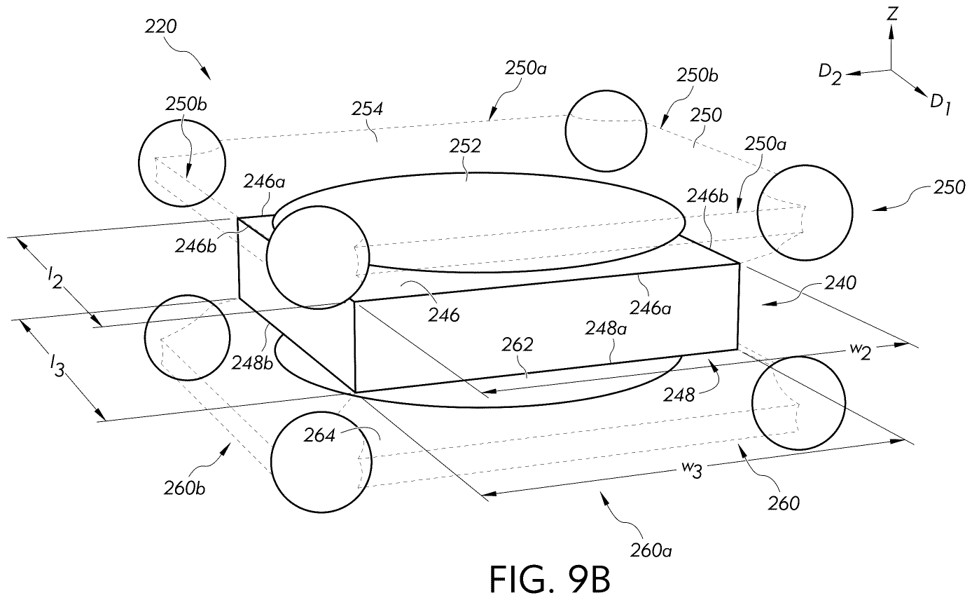

With reference to FIG. 9B, in embodiments, the first protector 250 may be coupled to a first side surface 246 of the first side 240-1 of the corrosion coupon 240, the first side surface 246 being defined by first longitudinal edges 246a and first lateral edges 246b. The first longitudinal edges 246a are spaced in a longitudinal direction D₁ of the degradation monitoring device 200 shown in FIGS. 9A and 9B, and define a length l₂ of the first side surface 246. The first lateral edges 246b spaced in a lateral direction D₂ of the degradation monitoring device 200 and define a width w₂ of the first side surface 246. In embodiments, the second protector 260 may be coupled to a second side surface 248 at the second side of the corrosion coupon 240, the second side surface 248 being defined by second longitudinal edges 248a and second lateral edges 248b. The second longitudinal edges 248a are spaced in the longitudinal direction D₁ of the degradation monitoring device 200 shown in FIGS. 9A and 9B, and define a length l₃ of the second side surface 248. The second lateral edges 248b are spaced in a lateral direction D₃ of the degradation monitoring device 200 and define a width w₃ of the second side surface 248.

In embodiments, a length l_{P1} (see FIG. 9A) of the first protector 250 is greater than the length l₂ of the first side surface 246 such that longitudinal end portions 250a of the first protector 250 overhang the first longitudinal edges 246a of the first side surface 246. In embodiments, a width w_{P1} (see FIG. 9A) of the first protector 250 is greater than the width w₂ of the first side surface 246 such that lateral end portions 250b of the first protector 250 overhang the first lateral edges 246b of the first side surface 246. In embodiments, a length l_{P2} (now shown in figures) of the second protector 260 is greater than the length l₃ of the second side surface 248 such that longitudinal end portions 260a of the second protector 260 overhang the second longitudinal edges 248a of the second side surface 248. In embodiments, a width w_{P2} (now shown in figures) of the second protector 260 is greater than the width w₂ of the second side surface 248 such that lateral end portions 260b of the second protector 260 overhang the second lateral edges 248b of the second side surface 248.

The first and second protectors 250, 260 may protect the corrosion coupon 240 from erosion caused by contact with the interior surface of the pipeline 110. For example, while in some embodiments, the magnetic positioning system 300 may adjust the position of the degradation monitoring device 200 such that the degradation monitoring device 200 floats in the fluid being transported in the pipeline 110 so as to minimize potential erosion caused by contact with the interior surface of the pipeline 110, in other embodiments, the magnetic positioning system 300 may adjust the position of the degradation monitoring device 200 such that the degradation monitoring device 200 slides along the interior surface of the pipeline 110. With respect to the latter embodiment wherein the degradation monitoring device 200 slides along the interior surface of the pipeline 110, the first and second protectors 250, 260 of degradation monitoring device 200 shown in FIGS. 8A and 8B may help prevent erosion-induced weight loss to the corrosion coupon 240 that might otherwise reduce the accuracy of the corrosion measurements.

The first and second protectors 250, 260 may be made of a soft material that will not scratch or otherwise damage the interior surface of the pipeline 110 and that can withstand the potentially harsh conditions within the pipeline 110. Exemplary materials for the soft material of the first and second protectors 250, 260 include silicone rubber, polyurethane, polytetrafluoroethylene (e.g., Teflon), ethylene propylene diene monomer rubber (EPDM rubber), neoprene, etc.). The first and second protectors 250, 260 may be coupled to the corrosion coupon 240 through any suitable means, such as, for example, an adhesive or screws 245 (see e.g., FIGS. 9A and 9B). In embodiments wherein screws 245 are used to couple the first and second protectors 250, 260 to the corrosion coupon 240, the screws 245 may be provided within countersink holes or counterbore holes (not shown) in the first and second protectors 250, 260 such that the heads of the screws 245 do not contact and damage the interior surface of the pipeline 110. In other embodiments, wherein the screws 245 are not provided within countersink holes or counterbore holes, the screws 245 may be made of a material that is sufficiently soft so as to avoid scratching or otherwise damaging the interior surface of the pipeline 110.

In the embodiment shown in FIG. 8A, the corrosion coupon 240 comprises a core 242 that is the magnetically attractable component 210 and an outer shell 244 comprising a test material that is different from a material of the core 242. As another example, in the embodiment shown in FIG. 8B, the first protector 250 comprises a core 252 that is the magnetically attractable component 210 and an outer shell 254 comprising a material that is different from a material of the core 252, and the second protector 260 comprises a core 262 comprising a second magnetically attractable component 211 and an outer shell 264 comprising a material that is different from a material of the core 262.

With reference again to FIGS. 9A and 9B, in embodiments of the degradation monitoring device comprising the corrosion coupon 240 and first and second protectors 250, 260, the first protector 250 may comprise a first plurality of outwardly protruding rotatable spheres 256 positioned at, for example, corners of the first protector 250. Similarly, the second protector 260 may comprise a second plurality of outwardly protruding rotatable spheres 266 positioned at, for example, corners of the second protector 260. The outwardly protruding rotatable spheres 256, 258 may allow the degradation monitoring device 200 to exhibit improved sliding on the interior surface of the pipeline 110 so as to further reduce the potential for the degradation monitoring device to scratch or otherwise damage the interior surface of the pipeline 110. In embodiments, the outwardly protruding rotatable spheres 256, 258 may be made from a soft non-ferromagnetic material that will not be attracted to the device engaging magnet 310 and that is capable of withstanding conditions of the system 100 (i.e., material degradation conditions of the system 100). The outwardly protruding rotatable spheres 256, 266 may be coupled to the first and second protectors 250, 260, respectively, within corresponding sockets provided within the respective protectors, as shown in FIG. 9A.

In one or more embodiments, the degradation monitoring device comprises an erosion coupon configured to measure the rate and/or extent of erosion within a pipeline or processing unit. In some embodiments, the degradation monitoring device comprises a biofilm coupon configured to measure the rate and/or extent of biofilm formation within a pipeline or processing unit. In some embodiments, the degradation monitoring device comprises a stress corrosion cracking coupon. In some embodiments, the degradation monitoring device comprises a scale formation coupon configured to measure the rate and/or extent of scale formation within a pipeline or processing.

Embodiments of the present disclosure are also directed to methods for determining material degradation conditions within a pipeline 110. In embodiments, methods for determining material degradation conditions within a pipeline 110 include: (a) positioning a device engaging magnet 310 at a first external position P_{E1} of the pipeline 110; (b) introducing a degradation monitoring device 200 into the pipeline 110, the degradation monitoring device 200 having initial characteristics and comprising a magnetically attractable component 210; (c) attracting the degradation monitoring device 200 to an initial position P1 adjacent to the first external position P_{E1} via through-wall magnetic coupling between the device engaging magnet 310 and the magnetically attractable component 210 of the degradation monitoring device 200; (d) moving the device engaging magnet 310 longitudinally (see FIG. 1) and/or circumferentially along an exterior surface 112 of the pipeline 110 to a second external position P_{E1} of the pipeline 110, thereby causing movement of the degradation monitoring device 200 to a measurement position P_{M} adjacent to the second external position P_{E2}; (e) maintaining, via through-wall magnetic coupling between the device engaging magnet 310 and the magnetically attractable component 210 of the degradation monitoring device 200, the degradation monitoring device 200 at the measurement position P_{M} for a test duration such that the degradation monitoring device 200 acquires modified characteristics; (f) extracting the degradation monitoring device 200 from the pipeline 110; and (g) comparing the modified characteristics of the degradation monitoring device 200 to the initial characteristics of the degradation monitoring device 200 to determine material degradation conditions associated with the measurement position P_{M}. The test duration may be decided based on various factors, including but limited to, the type of degradation monitoring device, the fluid characteristics and flow conditions, the material of the corrosion coupon, and the specific goals of the corrosion monitoring program. In embodiments, the test duration may be between 30 days and 180 days.

In the methods of the present disclosure for determining material degradation conditions within a pipeline 110, any of the embodiments described herein with respect to the system 100 and any suitable degradation monitoring device, e.g., any of the degradation monitoring devices 200 described herein, may be utilized. For example, in embodiments wherein the degradation monitoring device 200 comprises a corrosion coupon 220, the initial characteristics of the degradation monitoring device 200 may comprise an initial weight of the corrosion coupon 220, the modified characteristics of the degradation monitoring device 200 may comprise a modified weight of the corrosion coupon 220, and comparing the modified characteristics of the degradation monitoring device 200 to the initial characteristics of the degradation monitoring device 200 may comprise determining a difference between the initial weight of the corrosion coupon 220 and the modified weight of the corrosion coupon 220.

In other embodiments of the methods described herein, the initial characteristics of the degradation monitoring device 200 may comprise an initial surface condition of the corrosion coupon (e.g., corrosion coupon 220) characterized by well know microscopy methods, the modified characteristics of the degradation monitoring device 200 may comprise a modified surface condition of the corrosion coupon, and comparing the modified characteristics of the degradation monitoring device 200 to the initial characteristics of the degradation monitoring device 200 may comprise comparing the modified surface condition of the corrosion coupon (e.g., corrosion coupon 220), to the initial surface condition of the corrosion coupon. In embodiments wherein the degradation monitoring device 200 comprises the corrosion coupon 240 and first and second protectors 250, 260, the first and second protectors 250, 260 may be removed prior to assessing the modified characteristics of the degradation monitoring device 200.

In embodiments of the methods described herein, the device engaging magnet 310 may be moved longitudinally and circumferentially along the exterior surface of the pipeline 110 to the second external position P_{E2} of the pipeline 110. Further, (b) in the above-described embodiment may comprise introducing the degradation monitoring device 200 into the pipeline 110 using the injection system 500.

Embodiments of the present disclosure are also directed to methods for determining a corrosion profile of the pipeline 110. Methods for determining a corrosion profile of the pipeline 110 may include: (h) determining material degradation conditions at a plurality of measurement positions within the pipeline 110 by performing the methods described herein for determining material degradation conditions within the pipeline 110, for each measurement position of the plurality of measurement positions; and (i) processing the material degradation conditions determined in (h) to determine the corrosion profile of the pipeline 110.

While the three-dimensional positioner 320 is described herein with respect to the embodiment shown in FIG. 1, embodiments of the system 100 also include other three-dimensional positioner systems, such as, for example, the robot systems described in U.S. patent application Ser. No. 18/501,631, entitled “Robots for Servicing Metal Equipment,” the entire contents of which are incorporated herein by reference.

Furthermore, while embodiments of the system 100 are described with respect to a pipeline 110, the present disclosure is also directed to systems for determining material degradation conditions within a hollow structure, such as but not limited, storage tanks, reactors, pressure vessels, or other hollow structures, that contact fluids during typical use.

Unless otherwise specified, a range of values, when recited, includes both the upper and lower limits of the range as well as any sub-ranges therebetween. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the indefinite articles “a,” “an,” and the corresponding definite article “the” mean “at least one” or “one or more,” unless otherwise specified. It will also be understood that the various features disclosed in the specification and the drawings can be used in any and all combinations.

As used herein and in the appended claims, the words “comprise,” “has,” and “include” and all grammatical variations thereof are each intended to have an open, non-limiting meaning that does not exclude additional elements or steps.

Reference throughout this specification to “one embodiment,” “embodiments,” “certain embodiments,” “some embodiments,” “various embodiments,” “one or more embodiments,” or “an embodiment” means that a particular feature, structure, material, or characteristic described in connection with the embodiment is included in at least one embodiment of the disclosure. Thus, the appearances of the phrases such as “in embodiments,” “in one or more embodiments,” “in certain embodiments,” “in various embodiments,” “in one embodiment,” “in some embodiments,” or “in an embodiment” in various places throughout this specification are not necessarily referring to the same embodiment. Furthermore, the particular features, structures, materials, or characteristics described in connection with one embodiment may be combined in any suitable manner in one or more other embodiments.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

Having described the subject matter herein in detail and by reference to specific embodiments, it is noted that the various details disclosed herein should not be taken to imply that these details relate to elements that are essential components of the various embodiments described herein. Further, it will be apparent that modifications and variations are possible without departing from the scope herein, including, but not limited to, embodiments defined in the appended claims.

What is claimed is:

1. A system for determining material degradation conditions within a pipeline, the system comprising:
a degradation monitoring device comprising a magnetically attractable component; and
a magnetic positioning system comprising:
a device engaging magnet; and
a three-dimensional positioner configured to position the device engaging magnet longitudinally and circumferentially along an exterior surface of the pipeline,
wherein the magnetic positioning system is configured to selectively maintain the degradation monitoring device at a plurality of positions within the pipeline via through-wall magnetic coupling between the device engaging magnet and the magnetically attractable component of the degradation monitoring device.

2. The system of claim 1, wherein the degradation monitoring device comprises a corrosion coupon that is the magnetically attractable component.

3. The system of claim 2, wherein the corrosion coupon has an arcuate shape comprising a thickness, a length, and an arc width, and wherein the length of the arcuate shape is greater than or equal to the arc width of the arcuate shape, or the length of the arcuate shape is less than the arc width of the arcuate shape.

4. The system of claim 2, wherein the corrosion coupon has a spheroid shape.

5. The system of claim 1, wherein the magnetically attractable component of the degradation monitoring device and the device engaging magnet of the magnetic positioning system define a magnetic coupling force of at least about 0.039 newtons (N).

6. The system of claim 1, wherein the degradation monitoring device comprises a corrosion coupon comprising:
a core that is the magnetically attractable component; and
an outer shell comprising a test material that is different from a material of the core.

7. The system of claim 1, wherein the degradation monitoring device comprises:
a corrosion coupon;
a first protector positioned on a first side of the corrosion coupon; and
a second protector positioned on a second side of the corrosion coupon opposite the first side of the corrosion coupon,
wherein at least one of the corrosion coupon, the first protector, or the second protector comprises the magnetically attractable component.

8. The system of claim 7, wherein:
the first protector is coupled to a first side surface of the first side of the corrosion coupon, the first side surface being defined by:
first longitudinal edges spaced in a longitudinal direction of the degradation monitoring device and defining a length of the first side surface; and
first lateral edges spaced in a lateral direction of the degradation monitoring device and defining a width of the first side surface;
the second protector is coupled to a second side surface of the second side of the corrosion coupon, the second side surface being defined by:
second longitudinal edges spaced in the longitudinal direction of the degradation monitoring device and defining a length of the second side surface; and
second lateral edges spaced in the lateral direction of the degradation monitoring device and defining a width of the second side surface;
a length of the first protector is greater than the length of the first side surface such that longitudinal end portions of the first protector overhang the first longitudinal edges of the first side surface;
a width of the first protector is greater than the width of the first side surface such that lateral end portions of the first protector overhang the first lateral edges of the first side surface;
a length of the second protector is greater than the length of the second side surface such that longitudinal end portions of the second protector overhang the second longitudinal edges of the second side surface; and
a width of the second protector is greater than the width of the second side surface such that lateral end portions of the second protector overhang the second lateral edges of the second side surface.

9. The system of claim 7, wherein:
the first protector comprises a first plurality of outwardly protruding rotatable spheres; and
the second protector comprises a second plurality of outwardly protruding rotatable spheres.

10. The system of claim 1, further comprising an injection system configured to introduce the degradation monitoring device into the pipeline.

11. A method for determining material degradation conditions within a pipeline, the method comprising:
(a) positioning a device engaging magnet at a first external position of the pipeline;
(b) introducing a degradation monitoring device into the pipeline, the degradation monitoring device having initial characteristics and comprising a magnetically attractable component;
(c) attracting the degradation monitoring device to an initial position adjacent to the first external position via through-wall magnetic coupling between the device engaging magnet and the magnetically attractable component of the degradation monitoring device;
(d) moving the device engaging magnet longitudinally and/or circumferentially along an exterior surface of the pipeline to a second external position of the pipeline, thereby causing movement of the degradation monitoring device to a measurement position adjacent to the second external position;
(e) maintaining, via through-wall magnetic coupling between the device engaging magnet and the magnetically attractable component of the degradation monitoring device, the degradation monitoring device at the measurement position for a test duration such that the degradation monitoring device acquires modified characteristics;
(f) extracting the degradation monitoring device from the pipeline; and
(g) comparing the modified characteristics of the degradation monitoring device to the initial characteristics of the degradation monitoring device to determine material degradation conditions associated with the measurement position.

12. The method of claim 11, wherein:
the degradation monitoring device comprises a corrosion coupon;
the initial characteristics of the degradation monitoring device comprise an initial weight of the corrosion coupon;
the modified characteristics of the degradation monitoring device comprise a modified weight of the corrosion coupon; and
comparing the modified characteristics of the degradation monitoring device to the initial characteristics of the degradation monitoring device comprises determining a difference between the initial weight of the corrosion coupon and the modified weight of the corrosion coupon.

13. The method of claim 11, wherein:
the degradation monitoring device comprises a corrosion coupon;
the initial characteristics of the degradation monitoring device comprise an initial surface condition of the corrosion coupon;
the modified characteristics of the degradation monitoring device comprise a modified surface condition of the corrosion coupon; and
comparing the modified characteristics of the degradation monitoring device to the initial characteristics of the degradation monitoring device comprises comparing the modified surface condition of the corrosion coupon to the initial surface condition of the corrosion coupon.

14. The method of claim 11, wherein the device engaging magnet is moved longitudinally and circumferentially along the exterior surface of the pipeline to the second external position of the pipeline.

15. The method of claim 11, wherein (b) comprises introducing the degradation monitoring device into the pipeline using an injection system.

16. A method for determining a degradation profile of the pipeline, the method comprising:
(h) determining material degradation conditions at a plurality of measurement positions within the pipeline by performing the method of claim 11 for each measurement position of the plurality of measurement positions; and
(i) processing the material degradation conditions determined in (h) to determine the degradation profile of the pipeline.

17. A corrosion coupon comprising:
a core comprising a magnetically attractable material; and
an outer shell comprising a test material that is different from the magnetically attractable material of the core.

18. The corrosion coupon of claim 17, wherein the corrosion coupon has an arcuate shape comprising:
a thickness;
a length;
an outer radius;
an arc width; and
an arc height that is less than or equal to 50% of the outer radius.

19. The corrosion coupon of claim 17, wherein the corrosion coupon has a spheroid shape.

20. A system for determining material degradation conditions within a hollow structure, the system comprising:
a degradation monitoring device comprising a magnetically attractable component; and
a magnetic positioning system comprising:
a device engaging magnet; and
a three-dimensional positioner configured to position the device engaging magnet longitudinally and circumferentially along an exterior surface of the hollow structure,
wherein the magnetic positioning system is configured to selectively maintain the degradation monitoring device at a plurality of positions within the hollow structure via through-wall magnetic coupling between the device engaging magnet and the magnetically attractable component of the degradation monitoring device.

21. A corrosion coupon comprising a magnetically attractable material and having an arcuate shape comprising:
a thickness;
a length;
an outer radius;
an arc width; and
an arc height that is less than or equal to 50% of the outer radius.

22. A corrosion coupon comprising a magnetically attractable material and having a spheroid shape.

23. A degradation monitoring device comprising:
a corrosion coupon;
a first protector positioned on a first side of the corrosion coupon; and
a second protector positioned on a second side of the corrosion coupon opposite the first side of the corrosion coupon,
wherein at least one of the corrosion coupon, the first protector, or the second protector comprises a magnetically attractable component.
